(19) United States
(12) Patent Application Publication
(10) Pub. No.: US 2011/0185834 A1
(43) Pub. Date: Aug. 4, 2011

(54) Spinning Apparatus and Method of Assembly

(76) Inventor: Richard Pratt, Gorham, ME (US)

(21) Appl. No.: 12/696,146

(22) Filed: Jan. 29, 2010

(51) Int. Cl. F16H 55/17; B21K 1/30

(52) U.S. Cl. 74/459.5; 29/893.1

(57) ABSTRACT

The present invention is directed to a modular spinning apparatus adapted for the centrifugal separation of components in a biological sample. In one embodiment, the modular spinning apparatus comprises several non-lubricated elements which are designed and adapted for manual assembly within a sterile operating room. The elements comprise a lubrication free gearbox with a non-lubricated gear system therein, a rotatable riser shaft engaged with the gear system and a riser head fixedly engaged with the rotatable riser shaft.

### BACKGROUND

1. Field of the Invention

The present invention relates generally to centrifuge devices and more particularly to a fully autoclavable, manually assembled and disassembled spinning apparatus for separating components in biological material wherein the spinning apparatus contains encapsulated, non-lubricated gears.

2. Discussion of Background information

Medical devices and implements used during surgery require full sterilization prior to entering an operating room. Typically, most surgical implements are sterilized in a high temperature steam driven autoclave device. Similarly medical devices designed for surgical use also require autoclaving. If a device comprises lubricated components, autoclaving is prohibited, and the device is therefore prohibited from entering the operating room.

One such device is a centrifuge for use with separating components in organic matter, such as, for example, human fat extracted for autologous grafting. Such devices centrifuge fat and separate out the adipocytes, or fat cells, from the serum and oil so that the concentrated fat may be grafted. Existing devices present a number of undesirable issues. High speed centrifuges, although efficient, may destroy fat cells. More slow, manually rotated devices exist for such separation procedures but internal gearing requires lubrication thereby precluding use in operating rooms.

Although successful with regard to achieving the desired end result, these existing manually rotated devices inherently create inefficiencies and pose potential risks to the patient because they preclude operating room usage. Once fat is extracted and bagged, the bags are carried outside the operating room, attached to a hanging turntable and manually spun until separation occurs. The bags are then reintroduced into the operating room by medical personnel who must scrub down again and manually transport the bags of separated tissue from a non-sterile environment back into the operating room, potentially transferring pathogens into that sterile space. These manual rotation devices are typically heavy metallic devices comprising lubricated components therein and crude attachment mechanisms for retaining the fat receptacles for spinning The attachment means, for example clips or carabiners, pose potential risk for puncturing or tearing fat receptacle bags, which are typically plastic bags similar or identical to intravenous (IV) fluid type bags.

A need therefore exists for a compact, easily assembled and disassembled spinning device comprising no lubricated components and adapted for easily and safely retaining standard surgical receptacles within a sterile operating room while rotating the tissue filled receptacles at least at 200-400 rpm and no more than 1000 rpm, thereby enabling efficient centrifugal separation of tissue components without catastrophic destruction of tissue.

### SUMMARY OF THE INVENTION

The present invention solves the problems associated with existing surgical centrifuges and rotation devices intended to spin flexible receptacles for separation of components therein retained.

The present invention is directed to a modular spinning apparatus adapted for the separation of components in a biological sample. In one embodiment, the modular spinning apparatus comprises several elements which are designed and adapted for manual assembly within a sterile operating room: a gearbox, a rotatable riser shaft and a riser head fixedly engaged with the rotatable riser shaft. The modular spinning apparatus is designed to retain one or more receptacles each containing a biological sample requiring centrifugal separation of constituent components.

In one embodiment, the gearbox comprises a housing, a chamber defined by a hollow cavity within the housing and two bevel gears aligned and engaged within the cavity. The cavity is accessed through a removable cover selectively engaged with the housing, which comprises only 5 full walls when the removable cover is detached. Removing the cover completely exposes all components within the cavity, which contains therein no lubrication. The first of the two bevel gears has a horizontal axis of rotation and is disposed with the chamber adjacent the interior wall of a first side of the housing. The first bevel gear is mounted on a drive shaft extending through a first aperture extending through the first side of the housing.

In one embodiment, the rotatable riser shaft descends through a second aperture disposed in a second side of the housing that is perpendicular to the first side. The shaft then extends through the chamber and terminates at a proximal end within the chamber at a second bevel gear having a vertical axis of rotation such that the rotatable riser shaft rotates about its longitudinal axis. The teeth of the second bevel gear engage with the teeth of the first bevel gear so that rotating the drive shaft spins the first bevel gear which then rotates the second bevel gear and riser shaft therewith engaged. In certain embodiments, the distal end of the rotatable riser shaft has thereon an affixed riser head suspended apart from the gearbox, wherein the riser head comprises one or more retention members for securely and safely retaining receptacle bags.

The present invention further comprises a method for assembling the spinning apparatus. An embodiment of the method comprises providing a five walled housing wherein the five walls define a cavity accessed through a removable cover and wherein the housing comprises a first aperture extending though a first wall of the housing, a second aperture extending through a second wall of the housing, and a third aperture extending through a third wall of the housing that is oriented opposite the second wall so that the second and third aperture align. The embodiment of the assembly method also comprises inserting a rotatable drive shaft through the first aperture and mounting a first bevel gear onto the drive shaft so that the first bevel gear lies adjacent to and parallel with the interior surface of the first wall and so that the gear teeth of the first bevel gear face inward, into the cavity.

The method further comprises mounting a rotatable riser shaft through the second aperture so that the shaft extends through the cavity. The rotatable riser shaft mounts co-axially to a second bevel gear having a stem seated within the third aperture extending through the third wall of the housing. The method comprises mating the riser shaft coaxially with the second bevel gear such that the axis of rotation of the second bevel gear is perpendicular to the axis of rotation of the first bevel gear and so that the teeth of the second bevel gear enmesh with the teeth of the first bevel gear.

The method further comprises engaging a removable cover with a retention means to form a sealed chamber within the housing. In one embodiment, the retention means comprises a pair of retention lips formed along the opening of the cavity for retaining the slidably engaged removable cover therein so that the cavity and components therein are enclosed securely. The embodiment of the method further comprises fixedly engaging a riser head with the distal end of the riser shaft and affixing retention members thereon for supporting and retaining filled receptacles during use of the apparatus.

### BRIEF DESCRIPTION OF THE DRAWINGS

One will better understand these and other features, aspects, and advantages of the present invention following a review of the description, appended claims, and accompanying drawings in which:

FIG. 1 depicts a blown apart schematic of the components of one embodiment of the present invention.

FIG. 2 depicts the embodiment of FIG. 1 in a partially assembled state.

FIG. 3 depicts one embodiment of the present invention in a fully assembled state.

FIG. 4 depicts one embodiment of the spinning apparatus assembly method of the present invention.

### DETAILED DESCRIPTION

The present invention solves the problems associated with existing surgical centrifuges and spinners and provides a reliable, portable, modular spinner for use in sterile operating rooms.

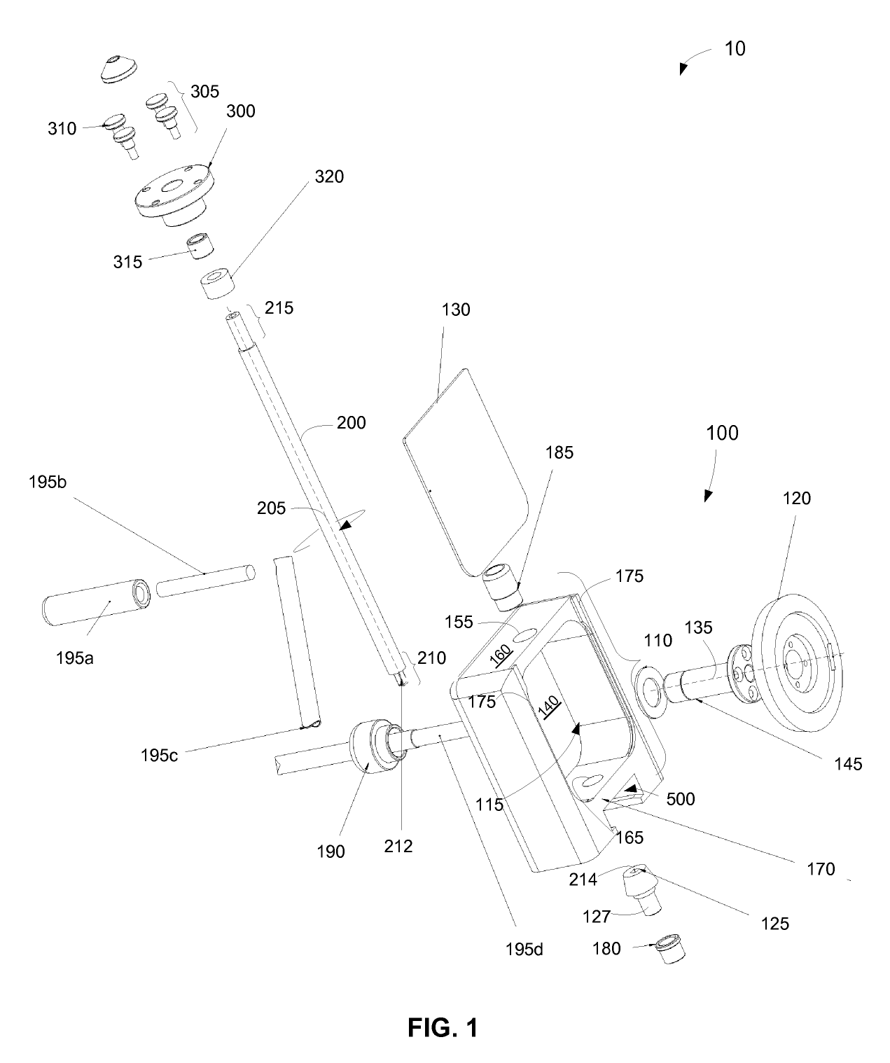

The present invention is directed to a modular spinning apparatus 10 adapted for the separation of components in a biological sample, such as, for example human fat. In one embodiment, the modular spinning apparatus 10 comprises several elements which are designed and adapted for manual assembly within a sterile operating room. As FIGS. 1 though 3 depict, the main components of the modular spinning apparatus 10 are a gearbox 100, a rotatable riser shaft 200 inserted through the gearbox 100 and a riser head 300 fixedly engaged with the rotatable riser shaft 200.

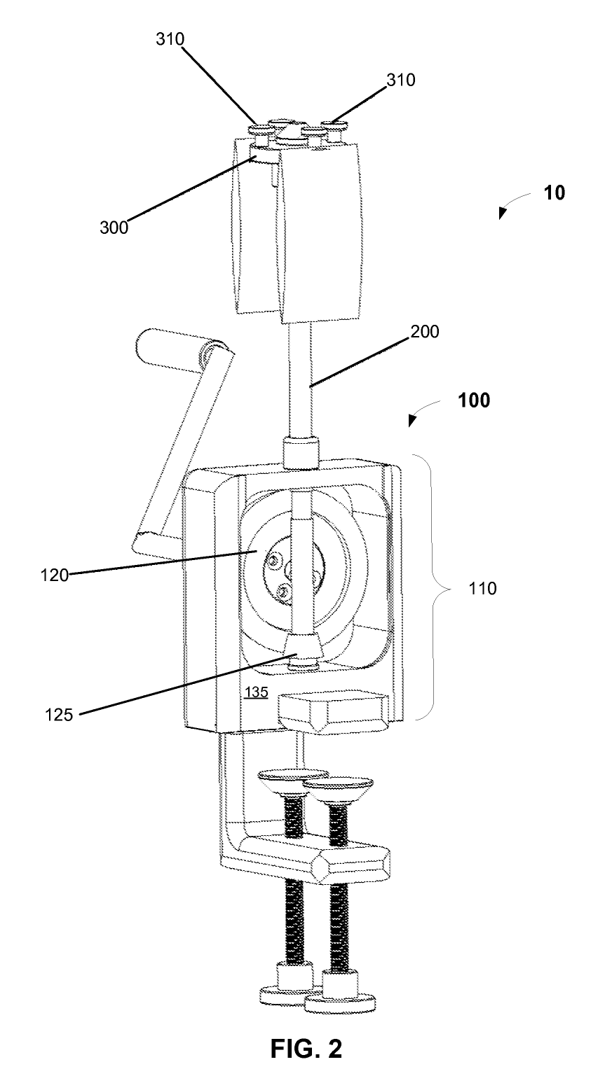

In one embodiment, the gearbox 100 comprises a housing 110 manufactured of an autoclavable metal material and manifesting dimensions equal to or smaller than sixteen inches by sixteen inches by twenty-four inches. Such sizing enables the housing 110 to fit with the confines of a standard surgical autoclave and enables comfortable portage and assembly with little or no exertion by hospital personnel. In one embodiment, the housing 110 comprises a chamber defined by a hollow cavity 115 bounded and defined by the five walls of the housing 110. A first bevel gear 120 and a second bevel gear 125 are aligned and engaged within the cavity 115, which is selectively enclosed by a removable cover 130. Opening or removing the cover 130 completely exposes all components within the cavity 115, which contains therein no lubrication. The first bevel gear 120 has a horizontal axis of rotation 135 and is disposed with the cavity 115 adjacent the interior surface of a first wall 140 of the housing. The first bevel gear 120 is mounted on a drive shaft 145 extending through a first aperture 150 extending through the first wall 140 of the housing. In the embodiment depicted in FIGS. 1 through 2, the first wall 140 of the housing is opposite from and parallel to the removable cover 130 during its engagement with the housing 110. In other embodiments, the first wall 140 may be another wall other than that facing the removable cover 130.

In one embodiment, the rotatable riser shaft 200 extends through a second aperture 155 extending through a second wall 160 of the housing 110. In the embodiment of FIGS. 1 through 3, the second wall 160 forms the upper surface of the housing 110. The rotatable riser shaft 200 then extends through the cavity 115 and terminates within the cavity 115 at a proximal end 210 at the second bevel gear 125 disposed within a third aperture 165 extending through a third wall 170 of the housing. FIGS. 1 through 3, the third wall 170 forms the bottom surface of the housing 110. In one alternate embodiment, the rotatable riser shaft 200 may extend through the cavity 115 in a sideways orientation wherein a distal end 215 opposite the proximal end 170 extends outward laterally from the apparatus 10. In another alternate embodiment, the rotatable riser shaft 200 may extend through the cavity 115 in an upside down orientation wherein the distal end hangs 180 beneath the apparatus 10.

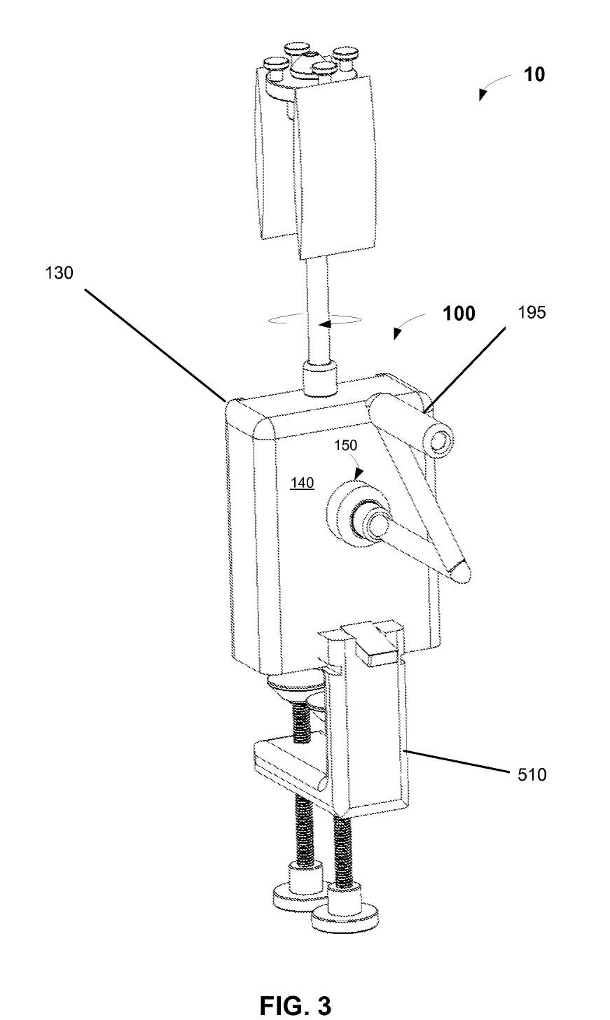

As depicted in FIGS. 2 and 3, the second bevel gear 125 has a vertical axis of rotation such that the rotatable riser shaft 200 rotates about its longitudinal axis 205. The teeth of the second bevel gear 125 engage with the teeth of the first bevel gear 120 so that rotating the drive shaft 145 spins the first bevel gear 120 which then rotates the second bevel gear 125 and riser shaft 200 engaged therewith. The proximal end 210 of the rotatable riser shaft 200 engages with the second bevel gear 125 through some manually executable mechanical means of affixation such as, for example, but not limited to, a slip fit interface, a press fit interface, a threaded interface, spring loaded lock pins, magnets and/or any combination of these mechanical affixation means. In the embodiment depicted in FIG. 1, for example, the proximal end 210 of the rotatable riser shaft 200 comprises a square shaped tooth 212 sized for slip fit mating with a square shaped slot 214 with the second bevel gear 125.

In certain embodiments, the distal end 215 of the rotatable riser shaft has thereon an affixed riser head 300 suspended apart from the gearbox by the length of the riser shaft 200 therebetween. In the embodiment of FIGS. 1 through 3, the riser head 300 manifests an unobtrusive disc shape such that the face of the disc defines a horizontal plane and the disc exhibits a low profile enabling laminar flow with little to no draft during rotation. Although the riser head 300 may exhibit any style or shape, such as a cambered wing or a suspended toric ring, a solid disc shape provides an adequate support surface for retention members 305 thereon and enables rotation without creating consequential drag that may lessen the effective centrifugal force created during rotation. Sufficient rotational and radial centrifugal forces are required to adequately separate components in bagged tissue hanging from the rotatable riser head, and counterproductive drag forces are undesirable.

As indicated in FIGS. 1 through 3, the riser head comprises one or more integrated retention members 305 projecting therefrom for securely and safely retaining receptacles containing biological material requiring centrifugal separation, such as human fat tissue which may contain oil and blood in addition to pure fat cells. Unlike the clips of prior art devices, the retention members 305 comprise no moving parts that might pinch a receptacle or bag and no sharp edges that could puncture a receptacle. The lack of moving parts on the retention members 305 eliminates potential for wear and catastrophic failure, thereby, further extending the longevity of the device, and the lack of moving parts, such as hinged carabiners further eliminates any need for lubrication which would preclude sterilization. In the embodiment of FIGS. 1 through 3, the retention members 305 are nail-shaped members rising above and extending from the riser head 305. A flange 310 at the top of each retention member 305 interacts with a receptacle retention feature, such as a hanging lip or button hole, slipped thereover, thereon and/or therearound. The flange 310 prevents the receptacle hanging therebeneath from sliding off of the retention member 305 during rotation of the rotatable riser shaft 200 and riser head 300 thereon. In one embodiment, the riser shaft 200, riser head 300, retention members 305, and flanges 310 comprise no sharp edges. In embodiments, the edges of the riser shaft 200, riser head 300, retention members 305, and flanges 310 are all broken, beveled, or rounded so that no surgical gloves, plastic bags or surgical protective wear contacting the apparatus 10 snags or tears. The lack of sharp edges thereby protects and maintains a sterile environment and reduces pathogen exposure risk for medical personnel as well as the patient.

Furthermore, in one embodiment, the riser shaft 200, riser head 300, retention members 305, and flanges 310 may be separately manufactured components affixed to one another via mechanical permanent and/or semi-permanent affixation means such as but not limited to screws, welds, rivets, pins, spring loaded locking pins, glue, epoxy, magnets, slip fit interfaces, and press fit interfaces between components. In another embodiment, one or more of these components may be manufactured from a single machined piece or may be cast as a unified assembly in a metal die casting process or plastics molding process, for example. In all embodiments intended for use in a surgical setting, the rotatable riser shaft 200, riser head 300 and retention members 305 extending therefrom are manufactured of materials capable of adequate sterilization for introduction into an operating room during surgery. In certain embodiments, the materials of manufacture for the rotatable riser shaft 200 and riser head 300 are capable of withstanding sterilization environments of at least 250 degrees Celsius without degradation. These materials may be for example, but are not limited to, Teflon® coated anodized aluminum, stainless steel, polyetheretherketone (PEEK), polythermide (Ultem), polysulfone, polyphenylsulfone, acetal copolymer (Celcon), ultra-high molecule weight polyethylene (UHMW) and other medical grade plastics.

Similarly, the first bevel gear 120 and second bevel gear 125 require no lubrication therebetween and therefore qualify for full sterilization in an autoclave or other sterilization process. To preclude the requirement for lubrication, the first bevel gear 120 and second bevel gear 125 are manufactured from dissimilar materials manifesting dissimilar surface treatments and capable of withstanding at least 250 degrees Celsius without degradation. For example, in one embodiment, the first bevel gear 120 is manufactured from hard anodized Teflon® dipped aluminum and the second bevel gear is manufactured from stainless steel. Alternatively, in another embodiment, the first bevel gear 120 may be manufactured from stainless steel and the second bevel gear 125 may be manufactured from hard anodized Teflon® dipped aluminum. Any number of material combinations are suitable for manufacturing the first bevel gear 120 and second bevel gear 125 such as but not limited to anodized aluminum, stainless steel, polyetheretherketone (PEEK), polythermide (Ultem), polysulfone, polyphenylsulfone, acetal copolymer (Celcon), ultra-high molecule weight polyethylene (UHMW) and other medical grade plastics.

Furthermore, using two bevel gears rather than, for example, a spiral and worm gear, prevents seizing or gear stripping caused by increased torque resulting from too great a gear tooth pitch angle. For example, in one embodiment, the first bevel gear 120 and the second bevel gear 125 present teeth oriented at a standard pitch angle of twenty degrees, which further assists with eliminating a need for lubrication. The present invention also addresses the challenge of selecting an appropriate gear ratio for achieving sufficient rotation speed without stripping the bevel gears 120, 125 or requiring the inclusion of additional moving parts. In certain embodiments, the gear ratio of the first bevel gear 120 to the second bevel gear 125 is between 1:3 and 1:7 and more preferably is 1:5. Such a gear ratio enables sufficient rotational speeds, for example up to 1000 rpm and more preferably between 300 and 700 rpm, to force separation between tissue components without introducing undue stresses on the non-lubricated moving components within the gearbox 100. The spinning apparatus 10 of the present invention therefore combines an optimal gear ratio with an optimal materials combination to enable centrifuging a biological sample at a desired rate of revolution to reduce the sample to its constituent components. These key design characteristics further enable sterilization of components of the spinning apparatus 10 so that the spinning apparatus 10 may be assembled quickly, employed and disassembled quickly and all within a sterile operating room.

The ability to assemble and disassemble the spinning apparatus 10 easily and quickly at the point of surgery addresses a major shortcoming presented by prior art centrifuges and spinners incapable of processing similar volumes of tissue safely and effectively within a sterile operating room. The present invention therefore comprises an assembly method 400 for efficiently manually assembling and disassembling the spinning apparatus 10 without requiring any tools or complex instructions for completion. The spinning apparatus 10 comprises a finite number of non-interchangeable parts so that component interactions are readily apparent to a user constructing the spinning apparatus 10 according to at least the following embodiment of the assembly method 400 of the present invention.

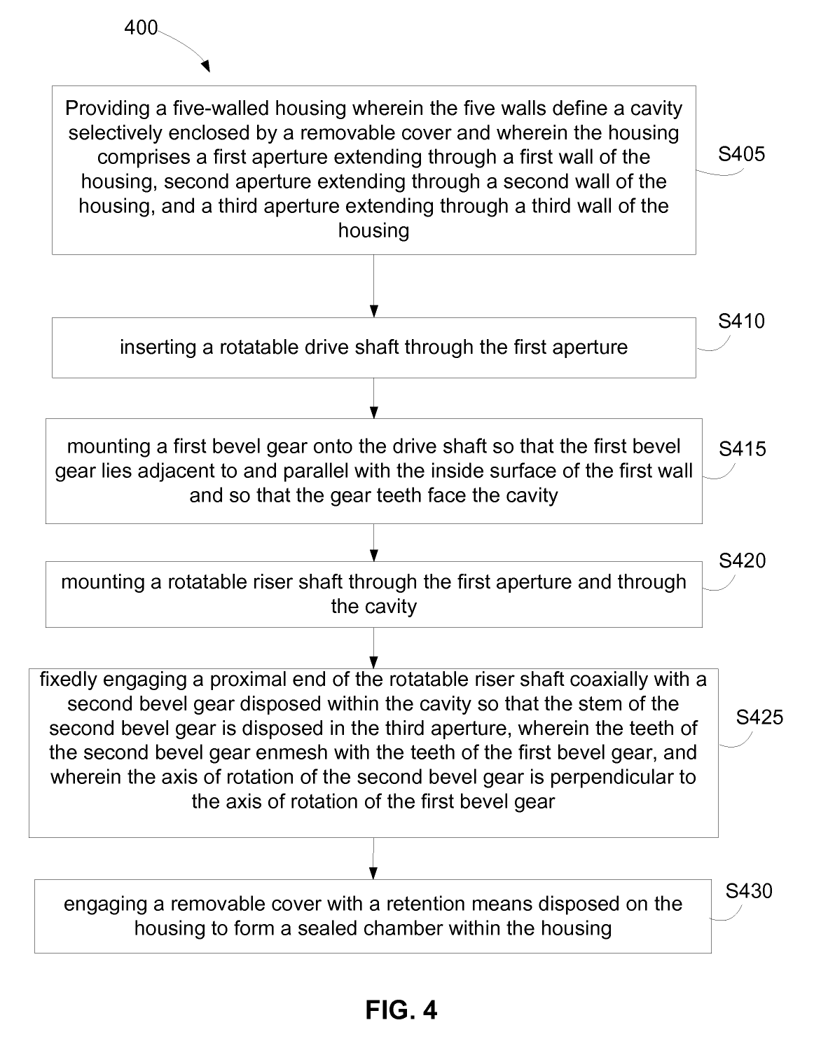

In one embodiment, depicted in FIG. 4, the assembly method 400 comprises a step S405 of providing a five walled housing 110 wherein the five walls define a cavity 115 selectively covered by a removable cover 130. The housing 110 comprises a first aperture 150 extending though a first wall 140 of the housing 110, an second aperture 155 extending through a second wall 160 of the housing 110, and a third aperture 165 extending through a third wall 170 of the housing 110, wherein the longitudinal axis of the second aperture 155 aligns with the longitudinal axis of third aperture 165. The indicated embodiment of the assembly method 400 also comprises a step S410 of inserting a rotatable drive shaft 145 through the first aperture 150 and a step S415 of mounting a first bevel gear 120 onto the drive shaft 145 so that the first bevel gear 120 lies adjacent to and parallel with the inside surface of the first wall 140 and so that the gear teeth of the first bevel gear 120 face inward, into the cavity 115.

The assembly method 400 further comprises a step S420 of mounting a rotatable riser shaft 200 through the first aperture 150 so that the shaft 200 extends into and through the cavity 115. At a step S425, the rotatable riser shaft 200 mounts co-axially to a second bevel gear 125 having a stem 127 seated within the second aperture 155 extending through the second wall 160 of the housing 110. The method comprises mating a proximal end 210 of the riser shaft 200 coaxially with the second bevel gear 125 such that the axis of rotation of the second bevel gear 125 is perpendicular to the axis of rotation 135 of the second first bevel gear 120 and so that the teeth of the second bevel gear 125 enmesh with the teeth of the first bevel gear 125. In other embodiments, the rotatable riser shaft 200 may mount to the second bevel gear 125 so that their axes are not coaxial, but for simplicity of the gearing mechanism for rotating the shaft 200, the riser shaft 200 and second bevel gear 125 are preferably coaxial.

The embodiment of the method of assembly 400 of FIG. 4 further comprises a step S430 of engaging a removable cover 130 with retention means 175 so that the cavity 115 and components therein are enclosed securely. In one embodiment, the retention means 175 comprises a pair of retention lips formed along the mouth of the cavity 115 so that the removable cover 130 slidably engages with the pair of retention lips to seal the cavity 115. In another embodiment, the retention means may comprise one or more non-lubricated hinges mating the removable cover to the housing. In another embodiment, the retention means 175 may comprise a removable lock pin mating the removable cover to the housing. The lock pin may insert, for example, through annular tabs (not shown) on the cover 130 aligned with annular tabs (not shown) on the housing 110. In yet another embodiment, the retention means may comprise one or more projections (not shown) extending from the cover and mating with one or more slots or holes (not shown) disposed in the housing.

Returning to FIG. 4, the exemplary embodiment of the method of assembly 400 further comprises fixedly engaging a riser head 300 with the distal end 215 of the riser shaft 200 and affixing retention members 305 thereon for supporting and retaining tissue receptacles during use of the apparatus 10.

Although the second aperture 155 is described in this embodiment as extending through the second wall 160, in other embodiments, the second aperture 155 may comprise a recess in the second wall 160 without extending therethrough all the way to create an open ended tunnel. In embodiments, the method may further comprise a step of lining the second aperture 155 with a gear bushing 180 and lining the first aperture 150 with a distal shaft bushing 185. Additionally, embodiments of the assembly method further comprise disposing a coaxial riser head bearing 315 and/or a clutch 320 atop the riser shaft 200 and between the riser shaft 200 and the riser head 300. Additionally, embodiments of the assembly method further comprise disposing a large gear bushing 190 in the first aperture 150. In one embodiment, all of the bushings 180, 185, 190 are sized such that each bushing only fits in a specific aperture 150,155, 165. In other embodiments, the apertures 150, 155, 165 may be identically sized so that the bushings 180, 185, 190 are interchangeable. In some embodiments, the bushings 180, 185, 190 are manufactured of a surgical plastic capable of sterilization, such as, but not limited to, polyetheretherketone (PEEK), polythermide (Ultem), polysulfone, polyphenylsulfone, acetal copolymer (Celcon), ultra-high molecule weight polyethylene (UHMW) and other medical grade plastics.

Although steps S405-S420 are recited in a particular order, other embodiments of the method of assembly 400 may comprise an alternate ordering of some or all of the method steps.

Returning now to embodiments of the modular spinning apparatus 10 of present invention, in one embodiment, the drive shaft 145 may extend outward to include a handle 195 thereon or fixedly engaged therewith for manual rotation by hospital personnel. The handle 195 may be modular in some embodiments, such as the embodiment of FIG. 1 in which the handle 195 is a combination of handle components 195a through 195d. In another embodiment, the handle 195 may be a unitary piece that includes the drive shaft 145. In preferred embodiments, the handle 195 is bent or angular so as to provide a moment arm for increased torque. In another embodiment, compressed air or automated motorized means may drive the driveshaft 145 at a constant rate of rotation such that a manually operated turn handle 195 is unnecessary.

Embodiments of the spinning apparatus 10 further comprise means for selectively attaching the apparatus 10 to a solid support surface during use to prevent the apparatus 10 from tipping during the centrifuging process. In one embodiment, the attachment means comprises a slot 500 in the second wall 160 of the housing 100 that accommodates an attachment clamp 510 best depicted in FIG. 3. The attachment clamp 510 may be inserted into the slot 500 from either the direction of the removable cover 130 of the housing 110 or from the direction of the first wall 140 so that the spinning apparatus 10 may be mounted and secured from either direction, thereby enabling attachment to a number of surfaces such as a planar tabletop or a beam, for example.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1) A modular spinning apparatus adapted for the separation of components in a biological sample, the modular spinning apparatus comprising the following elements adapted for manual assembly:
a) a gearbox comprising
i. a housing,
ii. a chamber defined by a hollow cavity within the housing wherein the cavity is accessed through a removable cover, wherein removing the cover completely exposes all components within the cavity and wherein the cavity contains no lubrication therein, and
iii. a first bevel gear having a horizontal axis of rotation, wherein the first bevel gear is disposed within the chamber adjacent the interior surface of a first wall of the housing and mounted on a drive shaft extending through a first aperture extending through the first wall;
b) a rotatable riser shaft disposed within an second aperture extending through a second wall of the housing, and extending through the chamber, wherein the rotatable riser shaft terminates at a proximal end within the chamber at a second bevel gear having a vertical axis of rotation, and wherein the teeth of the second bevel gear engage with the teeth of the first bevel gear; and
c) a riser head fixedly engaged with the proximal end of the rotatable riser shaft and suspended apart from the gearbox, wherein the riser head comprises one or more retention members.

2) The modular spinning apparatus of claim 1 wherein the gear ratio of the first bevel gear to the second bevel gear is between 3:1 and 7:1.

3) The modular spinning apparatus of claim 2 wherein the gear ratio of the first bevel gear to the second bevel gear is 5:1.

4) The modular spinning apparatus of claim 1 wherein the first bevel gear and the second bevel gear are manufactured from disparate materials.

5) The modular spinning apparatus of claim 4 wherein the first bevel gear is manufactured from hard anodized Teflon® coated aluminum.

6) The modular spinning apparatus of claim 5 wherein the second bevel gear is manufactured from stainless steel.

7) The modular spinning apparatus of claim 1 wherein the overall housing dimensions are no bigger than 16 inches wide by 16 inches deep by 24 inches high.

8) The modular spinning apparatus of claim 1 further comprising a distal flanged bushing bearing disposed within the second aperture between the housing the rotatable riser shaft.

9) The modular spinning apparatus of claim 1, further comprising a proximal flanged bushing bearing disposed within a third aperture extending through the third housing wall between the housing and the second bevel gear.

10) The modular spinning apparatus of claim 8 or 9 wherein the distal flanged bushing material and/or proximal flanged bushing material withstands temperatures up to 250 degrees Celsius.

11) The modular spinning apparatus of claim 10 wherein the bushing material is selected from the group consisting of polyetheretherketone (PEEK), Polythermide (Ultem), Polysulfone, Polyphenylsulfone, Acetal Copolymer (Celcon), ultra-high molecule weight polyethylene (UHMW) and other medical grade plastics.

12) The modular spinning apparatus of claim 1 wherein the riser head and one or more retention members comprise no sharp edges or corners.

13) The modular spinning apparatus of claim 12 wherein the riser head is disc shaped and comprises four evenly spaced raised bolts.

14) A method for manually assembling a modular spinning apparatus adapted for the separation of components in human fat comprising:
a) providing a five-walled housing wherein the five walls define a cavity selectively covered by a removable cover and wherein the housing comprises a first aperture extending through a first wall of the housing, a second aperture extending through a second wall of the housing, and a third aperture extending through a third wall of the housing wherein the longitudinal axis of the second aperture aligns with the longitudinal axis of the third aperture;
b) inserting a rotable drive shaft through the first aperture;
c) mounting a first bevel gear onto the drive shaft so that the first bevel gear lies adjacent to and parallel with the inside surface of the first wall and so that the gear teeth face the cavity;
d) mounting a rotatable riser shaft through the second aperture and through the cavity;
e) fixedly engaging a proximal end of the rotatable riser shaft with a second bevel gear disposed in the third aperture, wherein:
i. the teeth of the second bevel gear enmesh with the teeth of the first bevel gear,
ii. the axis of rotation of the second bevel gear is perpendicular to the axis of rotation of the first bevel gear, and
iii. wherein the first bevel gear and second bevel gear comprise no lubrication thereon or therebetween; and
f) engaging a removable cover with a retention means to form a sealed chamber within the housing.

15) The method of claim 14 further comprising inserting a tubular distal bushing within the second aperture for receiving the rotatable riser shaft therein;

16) The method of claim 14 further comprising inserting a tubular gear bushing within the third aperture for receiving an axial stem of the second bevel gear therein.

17) The method of claim 14 further comprising fixedly engaging a disc-like riser head with the distal end of the rotatable riser shaft.

18) The method of claim 17 further comprising affixing raised bolts to the top surface of the riser head.

19) The method of claim 17 wherein the first bevel gear and second bevel gear are manufactured from distinct materials.

20) The method of claim 17 wherein the first bevel gear and second bevel gear comprise different surface finishes.

21) The method of claim 14 wherein the retention means comprises a pair of retention lips formed along the mouth of the cavity and wherein the removable cover slidably engages with the pair of retention lips.

22) The method of claim 14 wherein the retention means comprises one or more non-lubricated hinges mating the removable cover to the housing.

23) The method of claim 14 wherein the retention means comprises a removable lock pin mating the removable cover to the housing.

24) The method of claim 14 wherein the retention means comprises one or more projections extending from the cover and mating with one or more corresponding slots or holes disposed in the housing.
